(19) United States
(12) Patent Application Publication
(10) Pub. No.: US 2024/0398157 A1
(43) Pub. Date: Dec. 5, 2024

(54) BREWING UNIT WITH HYDRAULIC INFUSION MEANS AND METHOD FOR OPERATING SUCH A BREWING UNIT

(71) Applicant: EUGSTER / FRISMAG AG, Amriswil (CH)

(72) Inventors: Wolfgang Riessbeck, Landschlacht (CH); Patrick Egger, Niederbüren (CH); Roman Scheurer, Felben-Wellhausen (CH)

(73) Assignee: EUGSTER / FRISMAG AG, Amriswil (CH)

(21) Appl. No.: 18/690,137

(22) PCT Filed: May 10, 2022
(86) PCT No.: PCT/EP2022/062535

§ 371 Date: Mar. 7, 2024

(30) Foreign Application Priority Data
Sep. 10, 2021 (DE) 10 2021 123 553.7

(51) Int. Cl. A47J 31/46; A47J 31/40

(52) U.S. Cl. CPC A47J 31/469; A47J 31/407

(57) ABSTRACT

The invention relates to a brewing unit (01) for a beverage preparation device for substrate portions, including a carrier (04) and a brewing chamber (11), which has at least two brewing chamber halves (02, 03), which are movable relative to one another in a first direction (03.1), wherein infusion means (20) for penetrating into a substrate portion and introducing brewing fluid into the substrate portion are arranged in one brewing chamber half (03) and are mounted movably with respect to the brewing chamber half (03) between a retracted position and a brewing position, wherein the infusion means (20) are connected in a fluid-conducting manner to a brewing-fluid feed (14) of the brewing chamber half (03) and a hydraulic cylinder (21) is likewise connected in a fluid-conducting manner to the brewing-fluid feed (14) and the working piston (24) thereof is connected to the infusion means (20) in such a way that filling of the hydraulic cylinder (21) with fluid causes the infusion means (20) to move in the direction of the brewing position. According to the invention, it is provided that the hydraulic cylinder (21) is arranged in a fluid-conducting manner between the brewing-fluid feed (14) and the infusion means (20).

### BACKGROUND OF THE INVENTION

The present invention relates to a brewing unit for a beverage preparation device for substrate portions, in particular a coffee machine for pre-portioned coffee units. Furthermore, the present invention relates to a beverage preparation device for substrate portions, in particular a coffee machine for pre-portioned coffee units having a brewing unit of this kind. Furthermore, the invention relates to a method for operating a brewing unit for a beverage preparation device for substrate portions, in particular for a coffee machine for pre-portioned coffee units.

A large number of brewing units and methods for their operation are already known from the state of the art, which are basically dedicated to the problem or task of opening a substrate portion or a pre-portioned coffee unit, for example a coffee capsule, in which air is enclosed in a solid casing or a solid capsule material in addition to ground coffee beans or coffee powder, as part of a brewing process in a beverage preparation device, and simultaneously or furthermore making it possible to introduce brewing fluid, preferably hot water, in the substrate unit and/or brewed beverage as a result of a brewing process from the substrate portion and/or to extricate a brewed beverage from the substrate portion and/or a brewing chamber (11) sealingly enclosing the substrate portion as a result of a brewing process, and to make it available to a user or operator as a beverage.

In this context, a solution has been established in the state of the art, in particular for opening and introducing brewing fluid, in which infusers disposed so as to be movable in one of preferably two brewing-chamber halves, are provided as part of an infusion component group, for example, the infusers being movably mounted between a retracted position and a brewing position with respect to the brewing-chamber half and being moved to a brewing position, preferably towards the substrate portion, together with the closing of the brewing-chamber halves or after the closing of the brewing-chamber halves in order to open or pierce the substrate portion or otherwise perforate or penetrate an outer material in order to subsequently be able to introduce brewing fluid in the substrate portion, for example ensured by cannula-like hollow tips.

Various approaches are known for the mechanism for moving or driving the infusers and/or infusion component group. One approach, which is quite common in the state of the art, provides for the infusers to be moved hydraulically between the retracted position and the brewing position. A hydraulic drive concept of this king makes use of the fact that pressurizable fluid, in particular water, is generally used or processed for the operation of the brewing unit and/or beverage preparation device, meaning a hydraulic transfer of the infusers can also often be provided via corresponding fluid paths or hydraulic circuits.

An example of this approach is known from EP 3 653 087 A1. For so-called hydraulic grooving, EP 1 567 036 B1, EP 2 218 668 A1, EP 2 488 075 A1, EP 2 833 766 A1, WO 2018/158179 A1, EP 2 480 115 A1, EP 2 432 354 A1, EP 1 247 480 A1, EP 2 348 930 A1 and EP 2 344 012 A1 are also known from the state of the art.

U.S. Pat. No. 5,302,407 A discloses a device and a method for producing coffee beverages, the device and the method being designed in particular for providing a possibility for nearly entirely discharging the water remaining in the tube system. According to the invention, hot brewing fluid is used to hydraulically press a piston against a second, fastened piston until a valve permits hot brewing fluid to enter the brewing chamber at the hydraulically driven piston via an overpressure.

EP 3 653 087 A1 discloses a brewing unit in which the device is transferred from an open to a closed position via a pressure chamber. According to the invention, water, for example, is used as a medium to generate the required pressure. In the closed position, a pointed tube fastened at the piston punctures a substrate portion/coffee capsule at the piston and introduced brewing fluid/water in the capsule.

US 2001 0011502 A1 also discloses a brewing unit in which initially a working position is reached from an idle position via manual actuation. Subsequently, water is used via conveyance using a pump to hydraulically move a piston and to reach a next position, which enables the brewing process. Via a temporally set valve another water pipe subsequently opens, the water pipe allowing a limited amount of water to flow through a coffee capsule.

The previous solutions with regard to hydraulically piercing or hydraulically moving or adjusting infusers in generic brewing units have the disadvantage that relatively complex fluid-technological designs and associated fluid-technological circuit systems have to be realized, which also means that a relatively high control effort has to be made in order to control the fluid circuits and/or hydraulic circuits permanently and reliably and to activate and deactivate them at the right time during the brewing process.

### SUMMARY OF THE INVENTION

With this background, the object of the present invention is to propose a brewing unit and a method for operating a brewing unit of this kind, which both overcome the disadvantages of the state of the art and, in particular, enable a simple implementation in terms of construction and control technology.

This object is attained by a brewing unit for a beverage preparation device for substrate portions, in particular a coffee machine for pre-portioned coffee units, the brewing unit comprising a carrier and a brewing chamber as generally known, the brewing chamber having at least two brewing-chamber halves movable in relation to each other in a first direction and infusers for penetrating the substrate portion and introducing brewing fluid in the substrate portion being disposed in a brewing-chamber half, the infusers being mounted between a retracted position and a brewing position so as to be movable with respect to the brewing-chamber half, the infusers being connected to a brewing-fluid supply of the brewing-chamber half in a fluid-conducting manner and a hydraulic cylinder also being connected to the brewing-fluid supply, the working piston of the hydraulic cylinder being connected in such a manner to the infusers that filling the hydraulic cylinder leads to a movement of the infusers to the brewing position, preferably along the first direction.

According to the invention, the brewing unit is characterized in that the hydraulic cylinder is disposed between the brewing-fluid supply and the infusers so as to conduct fluid and further in that a self-actuated valve, in particular a counter-pressure valve, is disposed in such a manner at the transition between the infusers and the hydraulic cylinder that it releases a fluid connection between the hydraulic cylinder and the infusers when a defined pressure, preferably a brewing pressure, has been reached in the hydraulic cylinder.

According to the invention, the brewing unit is characterized by the fact that the hydraulic cylinder is disposed between the brewing-fluid supply and the infusers in a fluid-conducting manner and that, furthermore, an automatic or self-controlled valve, in particular a back-pressure valve, is disposed at the transition between the infusers and the hydraulic cylinder in such a manner that it releases a fluid connection between the hydraulic cylinder and infusers when a defined pressure, preferably a brewing pressure, is reached in the hydraulic cylinder.

The brewing unit according to the invention thus makes use of the fact that fluid pressurized at any rate, namely the brewing fluid, has to be introduced in the infusers and subsequently in the substrate portion and/or the brewing chamber in the scope of the brewing process or the infusion process. Accordingly, the basic idea of the present invention is based on the fact that the brewing fluid, before it enters or is introduced in the brewing chamber and/or the substrate portion, fulfils a further functionality or a further function, namely by the brewing fluid first filling the hydraulic piston, which causes or effects the movement of the infusers from the retracted position to the brewing position. Thus, in contrast to the state of the art, no separate fluid flow or separate fluid circuit in addition to the fluid circuit or fluid flow of the brewing fluid has to be provided in order to move the infusers hydraulically.

A further expression of the basic principle of the present invention is the fact that no further measures need to be provided or features need to be realized in order to control, limit and/or terminate the supply of hydraulic fluid to the hydraulic cylinder. For the self-actuated valve at the transition between the infusers and the hydraulic cylinder ensures specifically that the infusers are transferred to the brewing position and then, when the defined pressure, preferably the brewing pressure, has been reached, the valve is opened, whereupon, however, brewing fluid can flow out of the hydraulic cylinder into the infusers. Advantageously, the flow or volume control for the brewing process can ensure that sufficient pressurized brewing fluid is supplied to carry out the brewing process, which in turn causes or contributes to the control of the hydraulic cylinder.

Only when the overpressure in the hydraulic cylinder falls below the defined pressure, preferably brewing pressure, for example because no more brewing fluid is supplied by the brewing-fluid supply, will the self-actuated valve close again without external control influences and accordingly terminate the brewing process. Subsequently, the hydraulic cylinder merely needs to be emptied to return the infusers from the brewing position to the retracted position, which can be done via a drain valve, for example, which will be discussed later in the description.

Advantageously, the counter-pressure valve can comprise a valve body which is subjected to a force to dispose it on a valve seat using pretensioning means, preferably a spring. The valve body and valve seat can be designed in the manner of a needle valve and interact with each other. The fluid connection to the hydraulic cylinder can then be established in such a manner that the fluid must lift the valve body off the valve seat against the pretension of the pretensioning means in order to open the valve. In this embodiment, the overpressure at which the counter-pressure valve opens is determined by the pretensioning means and the geometries of the valve body and the valve seat.

In other words, the brewing unit of the present invention achieves a largely automatic movement of the infusers, caused and controlled only by the provision of the brewing fluid, and an equally automatic initiation and termination of the brewing process via said valve.

According to a first preferred embodiment of the brewing unit, it can be intended that the brewing-chamber half, which receives the infusers or in which the infusers are disposed, has or comprises mechanical stops which limit the movement of the hydraulic cylinder, in particular the movement of the working piston of the hydraulic cylinder, and preferably define the brewing position of the infusers. This advantageously enables the working piston and thus also the infusers to be moved or driven as brewing fluid flows increasingly into the hydraulic cylinder, preferably until a brewing position of the infusers is reached via the stops, before an overpressure builds inside the hydraulic cylinder as brewing fluid continues to flow into the hydraulic cylinder, the overpressure ultimately causing the valve to open and thus to release the fluid channel or the fluid connection between the hydraulic cylinder and the infusers and thus finally to introduce the brewing fluid in the brewing chamber and/or the substrate portion.

The mechanical stops on the brewing-unit side, in particular on the brewing-chamber side, thus offer the possibility of a more reproducible brewing process in comparison to a situation or an embodiment in which the substrate portion or pre-portioned coffee unit itself acts as a stop and controls and/or limits the movement of the hydraulic cylinder, in particular the working piston and thus the infusers.

Advantageously, it may be further provided that deformers are associated with the infusers, the deformers being recessed such that the deformers cause a deformation of the surface or at least a part of the surface of the substrate portion, in particular the coffee unit, upon movement of the infusers from the retracted position to the brewing position after or during penetration of the infusers in a substrate portion. Thus, in an advantageous manner, the supply of brewing fluid to the hydraulic cylinder can have or cause a further advantageous effect or a further function in the brewing process. For the deformers, which may be necessary to transform the substrate portion, its surface or at least part of its surface, into a desired shape, can then be used to utilize the overpressure prevailing in the hydraulic cylinder and the resulting force, for example in the first direction, to cause the deformation of the substrate portion using the deformers, simultaneously or with a time delay to the penetration of the infusers in the substrate portion.

It is particularly preferred that the shape and movement of the deformers are adapted in such a manner to the substrate portion that the substrate portion is broken open when the infusers are moved to the brewing position. Preferably, a crack structure or other similar perforations can be introduced in a part of a shell or a surface material of the substrate portion. Simultaneously or alternatively, the deformers can also serve to tamp the beverage substrate, meaning when the infusers are transferred to the brewing position, the deformers exert a tamper pressure or a tamping force on the substrate portion.

According to a further, particularly preferred embodiment, it can be intended to provide mechanical drivers for transferring the brewing-chamber halves between an open position spaced apart from each other and a closed position bringing into contact the brewing-chamber halves against each other at contact surfaces. The brewing chamber, preferably realized by the two brewing-chamber halves moving in the first direction towards each other, can be closed by the mechanical drivers. Particularly preferably, the brewing-chamber halves can be opened automatically, which can be achieved, for example, by a return means or a spring means being pretensioned via the mechanical drivers during closing, which then supports or realizes the automatic opening.

According to a further particularly advantageous variant of the brewing unit, it may be intended that a cylinder of the hydraulic cylinder is formed by an inner casing also disposed in an outer casing of the brewing-chamber half so as to be movable in the first direction. The outer casing can, as will be described in detail below, cause a basic and preferably mechanically generated adjustment between an open position and a closed position of the brewing-chamber halves. The inner casing, which is movably mounted in the outer casing, can also serve or be used to support or create the sealing or sealing effect between the brewing-chamber halves in the area of the contact surfaces, particularly in the closed position of the brewing-chamber halves, by means of a movement with respect to the outer casing, preferably by the inner casing, which preferably forms the contact surfaces of at least one brewing-chamber half at one end or in an end region, also being subjected to force in the first direction and the contact surfaces thus being pressed against the complementary or opposite contact surfaces of the second brewing-chamber half.

The working piston of the hydraulic cylinder can then be moved in relation to the inner casing, which can be realized particularly easily and so as to save space if the cylinder of the hydraulic cylinder is formed by the inner casing or by a part of the inner casing itself and the working piston is movably mounted in the inner casing.

A further, particularly preferred embodiment intends, as already indicated above, that the inner casing on one end forms a contact surface for contacting and sealingly abutting against the other brewing-chamber half, preferably against a contact surface of the other brewing-chamber half.

Furthermore, it is particularly preferable that a hydraulic sealing cylinder is disposed and/or formed between the inner casing and the outer casing, the hydraulic sealing cylinder being connected to the brewing-fluid supply of the brewing-chamber half and in particular being disposed between the brewing-fluid supply and the hydraulic cylinder in a fluid-conducting manner, and causing a contact effect of the contact surface against the other brewing chamber, in particular against the contact surface of the other brewing chamber, particularly preferably via a force acting on the interior casing in the first direction, when filled with brewing fluid.

This means that a further particularly advantageous functionality or effect of the brewing unit can also be achieved by supplying the brewing unit with brewing fluid as part of the brewing process. For in addition to the hydraulic cylinder, which controls the movement of the infusers, and the valve, which equally influences the dispersion of the hydraulic cylinder and the infusers, the sealing or closure of the brewing-chamber halves can also be supported by the brewing fluid by also filling the hydraulic sealing cylinder with brewing fluid at the same time and/or upstream of the inflow of brewing fluid in the hydraulic cylinder, so that, for example, after the hydraulic cylinder has reached its mechanical stop, in particular the working piston, the pressure increases not only in the hydraulic cylinder but also in the sealing cylinder and the pressure building in the sealing cylinder, preferably via the inner casing mounted movably in the outer casing, causes the contact surfaces of the brewing-chamber halves to be pressed against each other or to be subjected to force towards each other, so that the sealing effect at the contact surfaces of the brewing-chamber halves is improved and ensured before and during the actual brewing process.

In another particularly preferred embodiment, the pressure in the sealing cylinder is also controlled by the self-actuated valve between the infusers and the hydraulic cylinder. This enables simple and effective control of both the hydraulic cylinder and the hydraulic sealing cylinder in a particularly advantageous manner. It is particularly preferable that the fluid connection or the fluid-conducting connection between the sealing cylinder and the hydraulic cylinder is unrestricted or uncontrolled, for example in the form of a simple flow opening. The corresponding pressures and forces can be set or controlled essentially by the surface area ratios and/or volume ratios between the sealing cylinder and hydraulic cylinder.

As previously described above, it can be particularly advantageous if the displacement or movement of the working piston of the hydraulic cylinder causes the displacement or movement of the infusers from the retracted position to the brewing position. In this context, it can also be particularly advantageous if the infusers are designed to interact with return means, in particular spring means, the return means causing the infusers to return to the retracted position and the infusers being correspondingly pretensioned fundamentally and/or at least in the brewing position by the return means.

In this embodiment, on the one hand, the hydraulic control of the hydraulic cylinder is to be realized in such a manner that, when the working piston is moved to reach the brewing position, it also charges the return means, in particular pre-tensions them, or compresses them further, and that accordingly, even when the valve is open, while brewing or introducing brewing fluid in the substrate portion and/or brewing chamber, the pressure in the hydraulic cylinder must always be maintained in such a manner that the return means do not move the infusers from the brewing position back in the direction of the retracted position.

A further particularly advantageous design of the brewing unit can intend that the inner casing of the brewing-chamber half has a rear section having a first smaller diameter for forming the cylinder of the hydraulic cylinder and a front section having a larger diameter for receiving the infusers, and preferably retractors of the infusers. As a result, the entire functionality of the brewing unit or the brewing-chamber half, which is controlled via the brewing-fluid supply, can be disposed in the outer casing of the brewing-chamber half, which is disposed so as to be movable with respect to the other brewing-chamber half and/or with respect to the carrier, in a particularly compact and space-saving manner.

It can also be advantageously intended that the diameter or the hydraulically active surface of the sealing cylinder is larger than the diameter or the hydraulically active surface of the hydraulic cylinder. As a result, a desired pressure and force distribution as well as an advantageous pressure and force development during the brewing process and during the inflow of the brewing fluid to the hydraulic cylinder and the hydraulic sealing cylinder can be set in an advantageous manner, without requiring additional or other control means, valves, flow or volume limiters or other control technology.

The object mentioned above is further attained by a beverage preparation device for substrate portions, in particular a coffee machine for pre-portioned coffee units having a brewing unit according to one of the designs mentioned above.

Furthermore, the object mentioned above is attained by a method for operating a beverage preparation device for substrate portions, in particular for coffee machines for pre-portioned coffee units, the brewing unit comprising a carrier and a brewing chamber, whose at least two brewing-chamber halves are moved between an open position and a closed position, preferably via mechanical drivers, infusers disposed in a brewing-chamber half being transferred to a brewing position from a retracted position for penetrating the substrate portion and introducing brewing fluid in the substrate portion after receiving a substrate portion in the open position and transmitting the brewing-chamber halves to the closed position, the infusers introducing brewing fluid in the substrate portion via a fluid connection to a brewing-fluid supply of the brewing-chamber half during the brewing process and a working piston of the hydraulic cylinder, which is mechanically connected to the infusers, moving the infusers to the brewing position when filling the hydraulic cylinder with fluid prior to brewing fluid being supplied to the infusers via a fluid connection between the brewing-fluid supply of the brewing-chamber half and a hydraulic cylinder, and further is characterized in that a fluid connection between the hydraulic cylinder and the infusers is released at the transition between the infusers and the hydraulic cylinder, in particular via a self-actuated valve, in particular a counter-pressure valve, upon reaching a defined pressure, preferably a brewing pressure, in the hydraulic cylinder and thus a continuous, in particular unbranched, fluid channel is generated between the brewing-fluid supply and the infusers, in particular of the substrate unit.

The special performance of the method as intended by the invention is therefore that, as indicated above, the brewing fluid first fills the hydraulic cylinder via the brewing-fluid supply and from there can reach the infusers and thus the brewing chamber and/or the substrate portion via the self-actuated valve, so that only the brewing fluid has to be made available in a desired manner, i.e., preferably at a desired flow rate and a desired overpressure, to control the movement of the infusers and initiate the brewing process.

In principle, in order to avoid unnecessary repetition with regard to the features, properties and advantages of the method according to the invention, reference is be made to the disclosure above of the brewing unit. This means that, in principle, features disclosed and described in terms of the method are to be regarded as described and claimable in terms of the device, and vice versa.

According to a particularly preferred embodiment of the method, it can be intended that the movement of the hydraulic cylinder, in particular the working piston, and the infusers is limited before reaching the defined pressure, preferably brewing pressure, in the hydraulic cylinder, preferably by means of mechanical stops, and preferably the brewing position of the infusers is defined.

According to a further advantageous development of the method, it can be intended that the surface of the substrate portion or at least a part of the surface of the substrate portion is deformed upon movement of the infusers from the retracted position to the brewing position after or during penetration of the infusers in the substrate portion, in particular by deformers being associated with the infusers, the deformers being recessed such that they abut against the substrate portion when moving the infusers to the brewing position.

It can also be advantageously intended that a pressure is built in a sealing cylinder, preferably via the brewing fluid, while transferring the infusers to the brewing position, the pressure forcing the brewing-chamber halves together in a closed position.

Furthermore, it can be advantageously intended that the pressure in the hydraulic cylinder and/or in the sealing cylinder is kept essentially constant during the entire brewing process, preferably by supplying brewing fluid, in particular pressurized brewing fluid, via the brewing-fluid supply of the brewing-chamber half during the brewing process once the defined pressure, in particular the brewing pressure, in the hydraulic cylinder has been reached, thereby compensating or even overcompensating for the brewing fluid flowing out of the hydraulic cylinder and/or sealing cylinder.

### BRIEF DESCRIPTION OF THE DRAWINGS

Advantageous embodiments, examples and aspects of the present invention are explained below with reference to the schematic, merely exemplary drawings.

FIG. 1: shows a sectional view of a brewing unit according to the invention in a closed position of the brewing-chamber halves and a retracted position of the infusers;

FIG. 2: shows a sectional view of a brewing unit according to the invention in a closed position of the brewing-chamber halves and a brewing position of the infusers.

### DETAILED DESCRIPTION

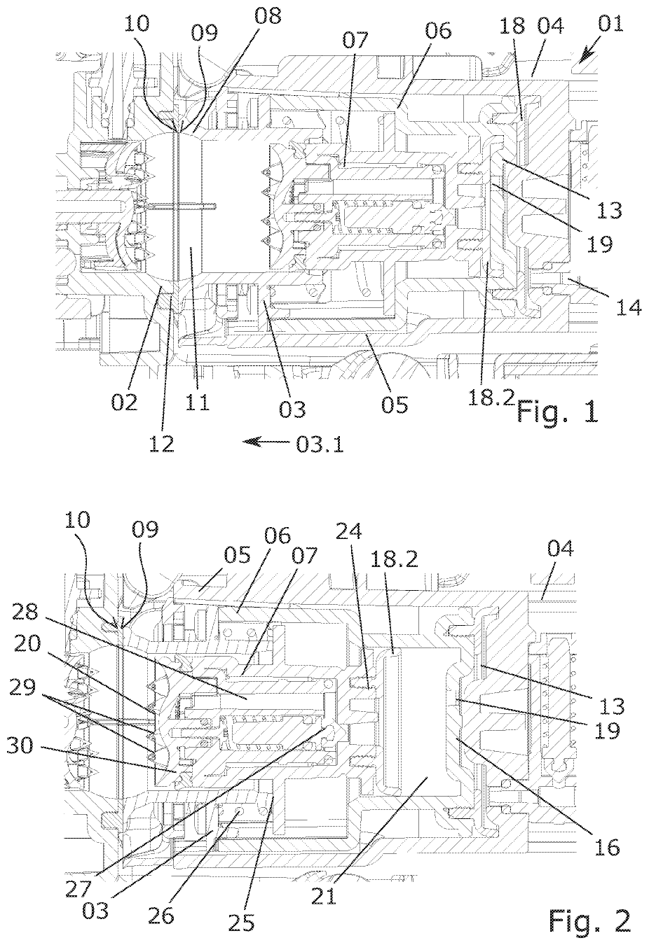

FIG. 1 shows a sectional view through a part of a brewing unit 01. The brewing unit 01 has a first brewing-chamber half 02 and a second brewing-chamber half 03. The brewing-chamber halves 02, 03 are shown in FIG. 1 in a closed position. For example, it may be intended that the brewing-chamber half 02 is fixed to a frame or carrier 04 and the brewing-chamber half 03 is movable with respect to the carrier 04 and essentially an outer casing 05 of the brewing-chamber half 03 can be moved mechanically by drivers or a drive device—which are not shown in FIG. 1—with respect to the carrier 04 in a first direction and against the first direction 03.1.

An inner casing 06 can be movably disposed or mounted in the outer casing 05, an infusion component group 07 having infusers 20 in turn being able to be movably mounted in the inner casing 06. At one end 08, the inner casing 06 forms a contact surface 09, in particular a circumferential contact surface 09, which comes into contact with an opposite contact surface 10 of the brewing-chamber half 02 in order to form the closed brewing chamber 11. On the side of the brewing-chamber half 02, the contact surface 10 can be formed partially or in sections by sealant 12, preferably in the form of a ring seal.

In the rear area of the brewing-chamber half 03, a hydraulic sealing cylinder 13 can be formed downstream of a brewing-fluid supply 14 in a fluid-conducting manner, the hydraulic cylinder 13 being formed by parts of the inner casing 06 and parts of the outer casing 05 as well as dynamic sealant 18. Via an uncontrolled fluid connection in the form of a fluid passage opening 19, brewing fluid can pass from the brewing-fluid supply 14 via the sealing cylinder 13 into a hydraulic cylinder 21, which in turn is formed by a part of the inner casing 06. In the rear part of the inner casing 06, which serves as a cylinder, a working piston 24 is mounted, which is partly formed by dynamic sealant 18.2 and is connected to the infusers 20 of an infusion component group 07 in a force-fit manner. The effect of the inflowing brewing fluid on the brewing unit or the brewing-chamber half 03 and the advantageous effect of the hydraulic functionalities of the brewing unit can be better recognized by comparing FIG. 1 and FIG. 2.

Compared to FIG. 1, FIG. 2 shows a state in which the brewing-chamber halves 02, 03, which are in the closed position, are pressed against each other and the infusers 20 additionally have also been transferred to the brewing position merely by brewing fluid having been introduced under pressure in the brewing unit or the brewing-chamber half 03 via the brewing-fluid supply 14. For internal pressure was built in both the hydraulic sealing cylinder 13 and the hydraulic cylinder 21. On the one hand, the internal pressure causes the contact surfaces 09, 10 to be pressed against each other via the inner casing 06. At the same time, however, the internal pressure in the hydraulic cylinder 21 also causes the working piston 24 to be displaced first and the infusers 20 to be displaced to the brewing position shown against the mechanical stop 25 against the restoring force of the return means 26. If the internal pressure continues to rise, caused by brewing fluid flowing in or being pressed in further, the self-actuated valve 27 finally opens and releases a fluid channel 28, which is connected to the hydraulic cylinder 21 in a fluid-conducting manner and opens into the infusion tips 29 of the infusers 20.

The deformers 30, which are recessed with respect to the infusers 20, can cause the deformation of a substrate portion simultaneously or downstream of the penetration of the infusers 20 into a substrate portion when the infusers 20 are transferred from the retracted position to the brewing position—transition between the position of FIG. 1 and FIG. 2.

As soon as the defined pressure, preferably brewing pressure, in the hydraulic cylinder 21 is no longer maintained or exceeded, for example because no more brewing fluid is supplied by the brewing-fluid supply 14, the valve 27 closes again automatically and no more brewing fluid can enter the infusers 20 or the fluid channel 28. If drainage of the hydraulic cylinder 21 and/or the hydraulic sealing cylinder 13 is then caused, for example via a drain valve, the application of force to the contact surfaces 09, 10 and thus the pressure effect or additional pressure effect of the contact surfaces 09, 10 is cancelled or reduced and at the same time the infusers 20 are transferred from the brewing position to the retracted position by the return means 26 moving the infusers 20 away from the mechanical stop 25, preferably until the position of the infusers 20 with respect to the inner casing 06 is reached again, as shown in FIG. 1.

Simultaneously or alternatively, directly before or slightly after draining the hydraulic cylinder/sealing cylinder 21, 13, a mechanical and preferably automatic opening of the brewing-chamber halves 02, 03 can commence and the closed brewing chamber 11 can be opened and thus the brewing-chamber halves 02, 03 can be transferred to an open position. The automatic opening can preferably also be triggered by return means or spring means, which are pretensioned or charged during, preferably mechanical, closure—to reach the position of FIG. 1.

### LIST OF REFERENCE NUMERALS

01 brewing unit
02 first brewing-chamber half
03 second brewing-chamber half
03.1 first direction
04 carrier
05 outer casing
06 inner casing
07 infusion component group
08 end
09 contact surface
10 contact surface
11 brewing chamber
12 sealant
13 sealing cylinder
14 brewing-fluid supply
18 sealant
18.2 sealant
19 fluid opening
20 infusers
21 hydraulic cylinder
24 working piston
25 mechanical stop
26 return means
27 valve
28 fluid channel
29 infusion tips
30 deformers

1. A brewing unit (01) for a beverage preparation device for substrate portions, the brewing unit (01) comprising a sleeve or a surface material, the brewing unit (01) comprising a carrier (04) and a brewing chamber (11), which has at least two brewing-chamber halves (02, 03) movable in relation to each other in a first direction (03.1), an infusion component group (07) having infusers (20) for penetrating a substrate portion and introducing brewing fluid in the substrate portion being disposed in a brewing-chamber half (03), the infusion component group (07) being mounted between a retracted position and a brewing position so as to be movable with respect to the brewing-chamber half (03), the infusers (20) being connected to a brewing-fluid supply (14) of the brewing-chamber half (03) in a fluid-conducting manner and a hydraulic cylinder (21) also being connected to the brewing-fluid supply (14), the working piston (24) of the hydraulic cylinder (21) being connected in such a manner to the infusers (20) that filling the hydraulic cylinder (21) with fluid leads to a movement of the infusers (20) to the brewing position,
wherein
the hydraulic cylinder (21) is disposed between the brewing-fluid supply (14) and the infusers (20) so as to conduct fluid and wherein a self-actuated valve (27) is disposed in such a manner at the transition between the infusers (20) and the hydraulic cylinder (21) that it releases a closable fluid connection between the hydraulic cylinder (21) and the infusers (20) when a defined pressure has been reached in the hydraulic cylinder (21).

2. The brewing unit according to claim 1,
further comprising
mechanical stops (25), which limit the movement of the hydraulic cylinder (21) and the infusers (20) and define the brewing position of the infusers (20).

3. The brewing unit according to claim 1,
wherein
deformers (30) are associated with the infusers (20), the deformers being recessed such that the deformers (30) cause a deformation of the surface of the substrate portion upon movement of the infusers (20) from the retracted position to the brewing position after or during penetration of the infusers (20) in a substrate portion.

4. The brewing unit according to claim 1,
further comprising
mechanical drivers for transferring the brewing-chamber halves (02, 03) between an open position spaced apart from each other and a closed position bringing into contact the brewing-chamber halves (02, 03) against each other at contact surfaces (09, 10).

5. The brewing unit according to claim 1,
wherein
a cylinder of the hydraulic cylinder (21) is formed by an inner casing (06) also disposed in an outer casing (05) of the brewing-chamber half (02, 03) so as to be movable in the first direction (03.1).

6. The brewing unit according to claim 5,
wherein
the inner casing (06) on one end forms a contact surface (09) for contacting and sealingly abutting against the other brewing-chamber half (02, 03).

7. The brewing unit according to claim 5,
wherein
a hydraulic sealing cylinder (13) is formed between the inner casing (06) and the outer casing (05), the hydraulic sealing cylinder (13) being connected to the brewing-fluid supply (14) of the brewing-chamber half (02, 03) and the hydraulic cylinder (21) in a fluid-conducting manner and causing a contact effect of the contact surface (09) against the other brewing chamber (11) when filled with brewing fluid.

8. The brewing unit according to claim 7,
wherein
the pressure in the sealing cylinder (13) is controlled by the self-actuating valve (27) between infusers (20) and hydraulic cylinder (21).

9. The brewing unit according to claim 5,
wherein
the inner casing (06) of the brewing-chamber half (02, 03) has a rear section having a first smaller diameter for forming the cylinder of the hydraulic cylinder (21) and a front section having a larger diameter for receiving the infusers (20), and retractors (26) for the infusers (20).

10. The brewing unit according to claim 5,
wherein
the diameter or the hydraulically active surface of the sealing cylinder (13) is larger than the diameter or the hydraulically active surface of the hydraulic cylinder (21).

11. A method for operating a brewing unit (01) of a beverage preparation device for substrate portions, the brewing unit (01) comprising a sleeve or a surface material, the brewing unit (01) comprising a carrier (04) and a brewing chamber (11), whose at least two brewing-chamber halves (02, 03) are moved between an open position and a closed position, an infusion component group (07) having infusers (20) disposed in a brewing-chamber half (02, 03) being transferred to a brewing position from a retracted position for penetrating the substrate portion and introducing brewing fluid in the substrate portion after receiving a substrate portion in the open position and transmitting the brewing-chamber halves (02, 03) to the closed position, the infusers (20) introducing brewing fluid in the substrate portion via a fluid connection to a brewing-fluid supply (14) of the brewing-chamber half (02, 03) during the brewing process and a working piston (24) of the hydraulic cylinder (21), which is mechanically connected to the infusion component group (07) having the infusers (20), moving the infusion component group (07) having the infusers (20) to the brewing position when filling the hydraulic cylinder (21) with fluid prior to brewing fluid being supplied to the infusers (20) via a fluid connection between the brewing-fluid supply (14) and a hydraulic cylinder (21),
wherein
a fluid connection between the hydraulic cylinder (21) and the infusers (20) is released at the transition between the infusers (20) and the hydraulic cylinder (21), upon reaching a defined pressure in the hydraulic cylinder and thus a continuous fluid channel (28) is generated between the brewing-fluid supply (14) and the infusers (20).

12. The method according to claim 11,
wherein
the movement of the hydraulic cylinder (21) and the infusers (20) is limited before reaching the defined pressure, preferably brewing pressure, in the hydraulic cylinder (21), preferably by means of mechanical stops, and preferably the brewing position of the infusers (20) is defined.

13. The method according to claim 11,
wherein
the surface of the substrate portion is deformed upon movement of the infusers (20) from the retracted position to the brewing position after or during penetration of the infusers (20) in a substrate portion, in particular by deformers (30) being associated with the infusers (20), the deformers (30) being recessed such that they abut against the substrate portion when moving the infusers (20) to the brewing position.

14. The method according to claim 11,
wherein
a pressure is built in a sealing cylinder (13) while transferring the infusers (20) to the brewing position, the pressure forcing the brewing-chamber halves together in the closed position.

15. The method according to claim 14,
wherein
the pressure in the hydraulic cylinder (21) and/or in the sealing cylinder (13) is kept essentially constant during the entire brewing process.

16. The brewing unit according to claim 1, wherein the brewing unit (01) is a coffee machine for pre-portioned coffee units.

17. The brewing unit according to claim 1, wherein the self-actuated valve (27) is a counter-pressure valve, and wherein the defined pressure is a brewing pressure.

18. The method according to claim 11, wherein the at least two brewing-chamber halves (02, 03) are moved via mechanical drivers.

19. The method according to claim 11, wherein the continuous fluid channel (28) is an unbranched continuous fluid channel.

20. The method according to claim 13, wherein the surface of the substrate portion is deformed by deformers (30) being associated with the infusers (20), the deformers (30) being recessed such that they abut against the substrate portion when moving the infusers (20) to the brewing position.
